(19) United States
(12) Patent Application Publication
(10) Pub. No.: US 2018/0086653 A1
(43) Pub. Date: Mar. 29, 2018

(54) WATER TREATMENT PROCESS USING PYROPHYLITE CERAMIC MEMBRANE

(71) Applicant: KOREA INSTITUTE OF SCIENCE AND TECHNOLOGY, Seoul (KR)

(72) Inventors: Chan Hyuk PARK, Seoul (KR); Yeong Mi JEONG, Seoul (KR); Sang Hyup LEE, Seoul (KR); Jae Woo CHOI, Seoul (KR); Yong Su CHOI, Seoul (KR)

(21) Appl. No.: 15/377,319

(22) Filed: Dec. 13, 2016

(30) Foreign Application Priority Data
Sep. 28, 2016 (KR) 10-2016-0124641

(51) Int. Cl. C02F 3/28; C02F 3/06; C02F 1/20; C02F 3/12; C02F 3/20; B01D 71/02

(52) U.S. Cl. CPC C02F 3/2853; C02F 3/06; C02F 1/20; C02F 3/2893; C02F 2101/16; C02F 3/201; B01D 71/025; B01D 71/027; C02F 2209/42; C02F 3/1273

(57) ABSTRACT

The present invention relates to water treatment process using pyrophylite ceramic membrane which purifies contaminant from wastewater by applying the pyrophylite ceramic membrane with immersion type, more particularly, in the water treatment process using the pyrophylite ceramic membrane including pyrophylite with 80 weight and alumina with 20 weight, characterized that comprises a S-1 step which pyrophylite ceramic membrane 10 is embedded and raw water is supplied to a reactor 100 blocked from outside, a S-2 step which obtains permenate water by operating suction pump 130 connected with the pyrophylite ceramic membrane 10, a S-3 step which recovers gas generated from the reactor 100 and a S-4 step which circulates part of gas generated from the reactor 100 to the reactor 100.

### BACKGROUND

### Field

The present disclosure relates to water treatment process using membrane, and more particularly, to water treatment process using pyrophylite ceramic membrane which purifies contaminant from wastewater by applying pyrophylite ceramic membrane with immersion type.

### Description of the Related Art

In the past, ecosystem could be sustained well because wastewater discharged by man was purified through natural purification. However, at this time, due to an increase in population and industrial development environmental pollution has become worse, therefore, research related to artificial treatment of wastewater has been done vibrantly.

Among these wastewater treatment technologies, membrane technology may reduce occurred sludge because an amount of entering chemicals is low when treating wastewater and constant level of treatment may be maintained because this may be influenced less by physical method for treatment regarding a change of water quality of wastewater. Further, automated operation may be possible, thereby having an advantage of reducing labor cost and operating cost.

Meanwhile, as a material used for wastewater treatment composite organic membranes (PES, PVDF, etc.) that are polymer are widely used. These composite organic membranes have advantage of excellent performance of penetration, easy fabrication and manufacture, on the other hand, have disadvantage of having being vulnerable to strong acid, strong base and high temperature, etc. In order to overcome this disadvantage, recent membrane market for wastewater treatment has become diversified; therefore, ceramic membranes that are capable of operating under extreme operating condition have come to the spotlight.

Ceramic membranes have excellent chemical resistance and durability now that they are suitable to treat wastewater in bad water quality. Al₂O₃, SiC, etc are used for representative materials for ceramic membranes; however, these materials are relatively expensive and import-dependent.

Therefore, development of ceramic materials for manufacturing membranes having excellent performance with a low cost and furthermore, development of water treatment process applying these membranes is being needed.

### SUMMARY

The present disclosure provides optimum water treatment process by using ceramic membranes for treatment of sewage or wastewater having excellent performance with the low cost.

A method for water treatment process using pyrophylite ceramic membrane of the present invention in the water treatment process using the pyrophylite ceramic membrane including pyrophylite with 80 weight and alumina with 20 weight, characterized by comprising a S-1 step which pyrophylite ceramic membrane 10 is embedded and raw water is supplied to a reactor 100 that is blocked from outside, a S-2 step which obtains permenate water by operating suction pump 130 connected with the pyrophylite ceramic membrane 10, a S-3 step which recovers gas generated from the reactor 100 and a S-4 step which circulates part of gas generated from the reactor 100 to the reactor 100.

Here, the S-1 step supplying the raw water is characterized in that if water level of the reactor 100 reaches less than a set point the raw water is supplied and reaches greater than the set point supplying of the raw water is discontinued.

Also, gas generated from the reactor 100 may comprise methane gas, CO₂ and nitrogen gas.

Further, the S-4 stage which circulates the part of gas generated from the reactor 100 to the reactor 100 is preferred to supply gas to a diffuser 110 which is located at a lower portion of the pyrophylite ceramic membrane 10.

Further, a method for the water treatment using the pyrophylite ceramic membrane of the present disclosure in the water treatment process using the pyrophylite ceramic membrane including pyrophylite with 80 weight and alumina with 20 weight is characterized by comprising a S′-1 step which supplies raw water to the reactor embedded in pyrophylite ceramic membrane 10, a S′-2 step which obtains permeate water by operating the suction pump 130 connected with the pyrophylite ceramic membrane 10 and a S′-3 step which supplies air to the reactor 100.

Here, the S′-1 stage which supplies the raw water is characterized in that if water level of the reactor 100 reaches less than a set point the raw water is supplied and reaches greater than the set point supplying of the raw water is discontinued.

Also, the air supplying to the reactor 100 is preferred to be compressed air.

Further, the S′-3 step which supplies the air to the reactor 100 is preferred to supply the air to the diffuser 110 which is located at the lower portion of the pyrophylite ceramic membrane 10.

A pyrophylite ceramic filter according to the present disclosure has advantage of manufacturing at low cost and having excellent bending strength because of large amount of pyrophylite reserves.

In addition, the pyrophylite ceramic filter according to the present disclosure has excellent performance removing contaminants compared to a conventional ceramic filter, moreover may maintain with low differential pressure, thereby having noticeable effect of reducing operating and maintaining cost.

### BRIEF DESCRIPTION OF THE DRAWINGS

FIG. 1 is a graph illustrating bending strength of pyrophylite ceramic membrane according to the present disclosure.

FIG. 2 is a graph illustrating porous ratio of pyrophylite ceramic membrane according to the present disclosure.

FIG. 3 illustrates an image of pyrophylite ceramic membrane containing 80 weight of pyrophylite.

FIG. 4 is an image of pyrophylite ceramic membrane module that may be applied to a wastewater treatment system.

FIG. 5 is a flowchart of manufacturing process of the pyrophylite ceramic membrane.

FIG. 6 is a schematic view of water treatment device according to a first exemplary embodiment that treats wastewater by using the pyrophylite ceramic membrane of the present disclosure.

FIG. 7 is a schematic view of water treatment device according to a second exemplary embodiment that treats wastewater by using the pyrophylite ceramic membrane of the present disclosure.

FIG. 8 is a test result of operation performance according to the first exemplary embodiment of the present disclosure.

FIG. 9 is a test result of operation performance according to the first exemplary embodiment of the present disclosure.

### DETAILED DESCRIPTION OF THE EMBODIMENT

Aspects described above and in the following may be understood more readily by reference to the following exemplary embodiments. The components corresponding to each drawing are to be referenced by like reference numerals. In addition, shapes or sizes of the components may be exaggerated more than actuality. Further, in the case of description with reference to prior art may be regarded as unnecessary description, the description with reference to the prior art will be omitted.

Hereinafter, the present disclosure will be described more fully with reference to the accompanying drawings.

The pyrophylite ceramic membrane according to the present disclosure may have excellent abrasion resistance, chemical resistance and heat resistance, and may treat wastewater stably.

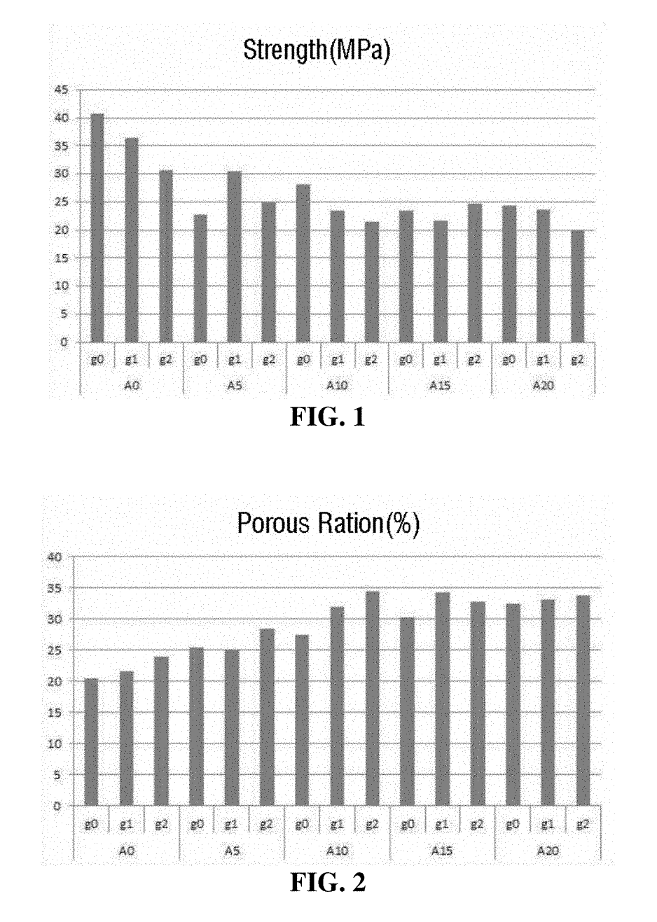

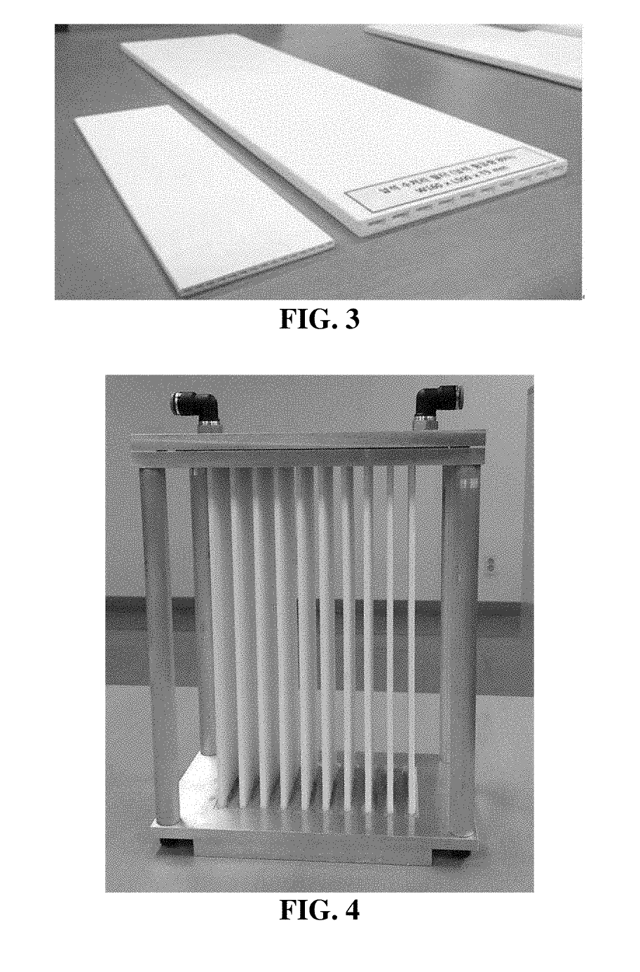

FIG. 1 is a view of the bending strength of the pyrophylite ceramic membrane according to the present disclosure, and FIG. 2 is a view illustrating the porous ratio of the pyrophylite ceramic membrane according to the present disclosure.

Also FIG. 3 illustrates the image of the pyrophylite ceramic membrane containing 80 weight of pyrophylite, and FIG. 4 is illustrates the image of pyrophylite ceramic membrane module that may be applied to the wastewater treatment system.

Referring to FIG. 1 to FIG. 4, the pyrophylite ceramic membrane may be consisted of a composition of the 80 weight of the pyrophylite and 20 weight of the alumina. Since ceramic membrane that used for treating wastewater has to be used under high-pressure, it has to have high strength, also, since air permeability as a membrane has to be excellent, forming pore is very important.

As described in FIG. 1, FIG. 2 and table 1 in the following, composition of the pyrophylite with 80 weight and the alumina with 20 weight were excellent in bending strength with 20 MPa in test of composition development, and in composition added content of graphite which is pore former herein with 2 weight the porous ratio is very high with 33%, so the air permeability was excellent.

Because the pyrophylite which is a non-metallic mineral has large amount of reserve, the ceramic membrane using pyrophylite has advantage of having excellent performance and inexpensive.

TABLE 1

| Sample Name | Pyrophylite | Alumina | Graphite |
|---|---|---|---|
| A0g0 | 100 weight | 0 weight | 0 weight |
| A0g1 | | | 1 weight |
| A0g2 | | | 2 weight |
| A5g0 | 95 weight | 5 weight | 0 weight |
| A5g1 | | | 1 weight |
| A5g2 | | | 2 weight |
| A10g0 | 90 weight | 10 weight | 0 weight |
| A10g1 | | | 1 weight |
| A10g2 | | | 2 weight |
| A15g0 | 85 weight | 15 weight | 0 weight |
| A15g1 | | | 1 weight |
| A15g2 | | | 2 weight |
| A20g0 | 80 weight | 20 weight | 0 weight |
| A20g1 | | | 1 weight |
| A20g2 | | | 2 weight |

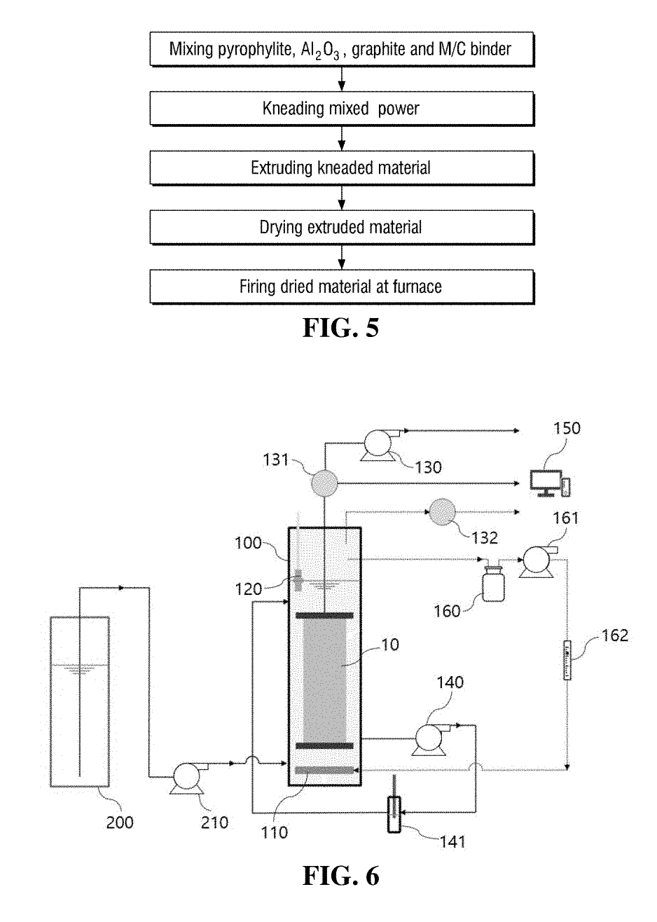

FIG. 5 is the flowchart of the manufacturing process of the pyrophylite ceramic membrane. Referring to FIG. 5, a method for manufacturing of the pyrophylite ceramic membrane may comprise dry mixing pyrophylite, Al₂O₃, graphite and M/C binder by using blender, kneading with kneader by adding water to mixed powder, extruding the kneaded material by using extruder, drying flat tubular extruded material at room temperature, and firing dried material at furnace for firing.

First, dry mix the pyrophylite, Al₂O₃, graphite and M/C binder by using the blender.

Next, knead by adding the water to the mixed power for 30 minutes with the kneader.

Next, extrude the kneaded material using the extruder.

Next, dry the flat tubular extruded material with hot air dryer at the room temperature up to 80 for 24 hours.

Next, dried material is fired for 2 hours in 1250 at furnace which is atmospheric.

Hereinafter, a method for wastewater treatment using ceramic filter of the present disclosure will be described.

FIG. 6 is the schematic view of the water treatment device according to the first exemplary embodiment that treats wastewater by using the pyrophylite ceramic membrane of the present disclosure, and comprises the reactor 100 having predetermined size and shape embedded in the pyrophylite ceramic membrane 10 of the present invention and the storage tank 200 which is in order to store raw water to be treated.

The water treatment process according to the first exemplary embodiment using like the above device is a process related to decomposition of contaminants by anaerobes and remove contaminants by the membrane, it comprises the S-1 step which pyrophylite ceramic membrane 10 is embedded and the raw water is supplied to the reactor 100 that is blocked from the outside, the S-2 step which obtains the permenate water by the operating suction pump 130 connected with the pyrophylite ceramic membrane 10, the S-3 step which recovers the gas generated from the reactor 100 and the S-4 step which circulates part of the gas generated from the reactor 100 to the reactor 100.

Describing the process in more detail, it supplies the raw water to the reactor 100 by using raw water supply pump 210 that is installed in the middle of pipe which connects the reactor 100 and the raw water storage tank 200. Further, after the raw water is supplied or by operating the suction pump 130 connected with the membrane 10 together with supply, permeate water that permeates the membrane 10 is obtained.

Here, the raw water supplying to the reactor 100 may controlled by water level sensor 120 provided in the reactor 100. The more permeate water is obtained by the suction pump 130, the water level of the reactor 100 is to be lower, when the water level reaches less than the set point, the raw water is supplied by operating the raw water supply pump 210, and when the water level reaches greater than the set point, supplying of the raw water is discontinued.

Meanwhile, in the pipe that connects the suction pump 130 and the membrane 10, providing the permeate water pressure gauge 131 is preferred, and it is more preferred that measured value of the pressure gauge 131 is to be stored at data storage portion 150.

Commonly, in the case of suction-type membrane, permeate performance is declined since micropore of the membrane is to be accumulated as permeate time or an amount of permeate, in order to operate the membrane efficiently the permeate performance has to be recovered through physical or chemical cleaning at predetermined intervals. Although the permeate time is not long, operating condition needs to be changed because device including the membrane may be damaged when the water level of the raw water becomes worse.

Therefore there is an advantage of handling effectively with reference to the above problem if measured value of the permeate water pressure gauge 131 is to be stored at the data storage portion at continuously or discontinuously.

In the meantime, it is more preferably provided circulation pump 140 to circulate and mix concentrate water uniformly in order that measure pH and ORP (Oxidation Reduction Potential) in the reactor 100 accurately.

The ORP measuring device 141 provided on circulation line that connects the circulation pump 140 and the reactor 100 is to understand whether the concentrate water in the reactor is in normal anaerobic state. That is, ORP values are measure of judgment that how easily substrate lose or obtain electron, it uses a principle generating an electric potential difference when occurring electron transfer two materials therebetween, as oxidation degrees of the substrate become higher a positive electric difference is obtained and as reduction of the substrate becomes larger a negative electric difference is obtained. Anaerobic microorganisms grow in condition of having negative electric difference of reducing condition, also methanogen activates in complete anaerobic state, and usually anaerobic condition is known that ORP measured value is about −500 mv to −200 mv.

In a first exemplary embodiment of the present disclosure, since the anaerobic microorganisms proliferate at the reactor 100, so methane gas, CO₂ and nitrogen gas caused by action of the microorganisms are mostly generated. The above gases may be utilized as useful resources, thus at predetermined location of the reactor 100 a separate return line in order to collect the gases and a collecting gas flowmeter 132 that is capable of measuring flow of gas to be collected may be further provided.

As described above, in the water treatment process using the membrane since the membrane fouling that is reduced depending on the permeate time or permeate volume occurs, thus performing physical cleaning periodically or aperiodically is common.

The present disclosure further provides removing contaminants attached to the membrane 10 by supplying gas to lower portion of the membrane when obtaining permeate water and/or supplying raw water.

Here, the gas that is supplied to the lower portion of the membrane 10 is preferably gas which does not include oxygen, in particular, in the first exemplary embodiment of the present disclosure, supplying to the reactor 100 by collecting some of methane gas, CO₂ and nitrogen gas that are occurred from the reactor 100 is more preferable.

Meanwhile, description of symbol 161 is a safety bottle. The gas occurred from the reactor 100 is about 35° C., which is higher than temperature in atmosphere thus water may be generated by condensation depending on temperature difference. This water may cause breakdown of a gas circulation pump 16, thus supplying to the gas circulation pump 16 after removing the water is preferred.

While describing the first exemplary embodiment in detail, it is described by separating the S-1 step to the S-4 step; however, the above steps may be proceeded one or more steps among the steps at the same time unless the steps must be proceeded in order, also it is clear that order of the steps may be different to those skilled in the art.

Hereinafter a second exemplary embodiment treating wastewater by using the pyrophylite ceramic membrane according to the present disclosure will be described.

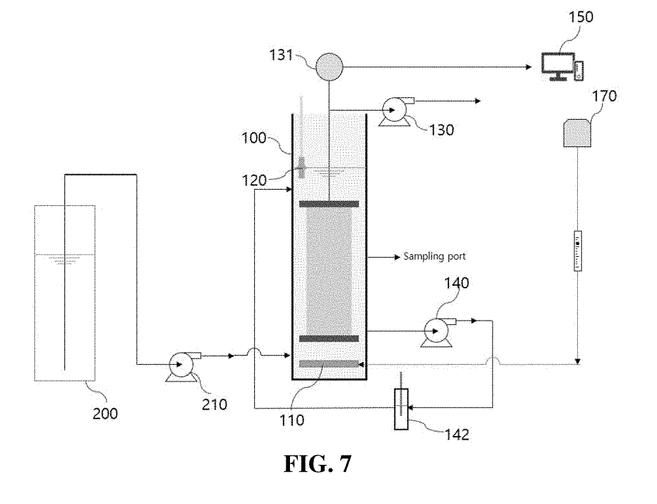

As illustrated in FIG. 7, the water treatment device that is able to be used for the second exemplary embodiment comprises the reactor 100 having predetermined sizes and shapes that is embedded in the pyrophylite ceramic membrane of the present disclosure and the raw water storage tank 200 which is in order to store the raw water to be treated.

Unlike the first exemplary embodiment which proliferate the anaerobic microorganisms, the second exemplary embodiment opens the reactor 100 because aerobic microorganisms proliferate.

The water treatment process using the device according to the second exemplary embodiment, comprises a S′-1 step which supplies raw water to the reactor 100 embedded in pyrophylite ceramic membrane 10, a S′-2 step which obtains permeate water by operating the suction pump 130 connected with the pyrophylite ceramic membrane 10 and a S′-3 step which supplies air to the reactor 100.

Describing the process in more detail, the raw water is supplied to the reactor 100 using the raw water supply pump 210 which is installed in the middle of pipe connecting the reactor 100 and the raw water storage tank 200. Also the permeate water is obtained by operating the suction pump 130 which is connected to the membrane 10 after supplying the raw water or together with supplying the raw water.

Here, the raw water supplying to the reactor 100 may be controlled by the water level sensor 120 provided in the reactor 100. The more permeate water is obtained by the suction pump 130, the water level of the reactor 100 becomes low, when the water level reaches less than the set point the raw water is supplied by operating the raw water supply pump 210, and when the water level reaches greater than the set point supplying the raw water is discontinued.

Meanwhile, in the pipe that connects the suction pump 130 and the membrane 10, providing the permeate water pressure gauge 131 is desirable, and it is more desirable that measured value of the pressure gauge 131 is to be stored at the data storage portion 150.

Commonly, in the case of the suction-type membrane, the permeate performance is declined since the micropore of the membrane is to be accumulated as permeate time or an amount of permeate, in order to operate the membrane efficiently the permeate performance has to be recovered through physical or chemical cleaning at predetermined intervals. Although the permeate time is not long, operating condition needs to be changed because the device including the membrane may be damaged when the water level of the raw water becomes worse.

Therefore there is an advantage of handling effectively with reference to the above problem if measured value of the permeate water pressure gauge 131 is to be stored at the data storage portion at continuously or discontinuously.

Meanwhile, it is preferably provided the circulation pump 140 to circulate and mix the concentrate water uniformly in order that measure pH and DO (Dissolved Oxygen) in the reactor 100 accurately.

As described above, in the water treatment process using the membrane since membrane fouling that is to be reduced depending on the permeate time or permeate volume occurs, thus performing physical cleaning periodically or aperiodically is common.

The present disclosure further provides removing contaminants attached to the membrane 10 by supplying compressed gas from compressor 170 to lower portion of the membrane when obtaining the permeate water and/or supplying the raw water.

Particularly, since the aerobic microorganisms are needed supplying of oxygen air supplying to the lower portion also performs supplying sufficient oxygen to the aerobic microorganisms living in the reactor.

Meanwhile it is not illustrated in the drawings, the diffuser 110, the water level sensor 120, the suction pump 130, the circulation pump 140, the raw water supply pump 210, etc that control the device of the present disclosure may be provided, also it is described by separating the S′-1 step to the S′-3 step while describing the second exemplary embodiment in detail; however, the above steps may be proceeded one or more steps among the steps at the same time unless the steps must be proceeded in order, also it is clear that order of the steps may be different to those skilled in the art.

Hereinafter, an experimental example 1 using the first exemplary embodiment of the present disclosure will be described.

### Experimental Example 1

In order to confirm effect of the pyrophylite ceramic membrane according to the present disclosure the water treatment process together with conventional ceramic membrane corresponding to 0.3 mm of pore size was performed.

As indicated in table 2, representative water lever of the raw water is 789.6 mg/L of TCOD, 305.8 mg/L of TOC, 38.2 mg/L of T-N and 8.5 mg/L of T-P.

TABLE 2

| TCOD | TOC | T-N | T-P | Na | NH4—N | K | Mg | Ca |
|---|---|---|---|---|---|---|---|---|
| (mg/ | (mg/ | (mg/ | (mg/ | (mg/ | (mg/ | (mg/ | (mg/ | (mg/ |
| L) | L) | L) | L) | L) | L) | L) | L) | L) |
| 789.6 | 305.8 | 38.2 | 8.5 | 170.1 | 64.6 | 11.5 | 5.2 | 9.7 |

Table 3 indicates specific operating condition in the exemplary embodiment, pH scale of the raw water in the reactor is retained 6.41±0.43, ORP (my) is retained −444.30±−18.94 and water temperature was 33.23±1.59. Also hydraulic retention time (HRT) was set as 18Hr and 42Hr, flux was set as 2.7 LMH and 1.1 LMH respectively and it was operated to have stopping time for one minute after filtration for four minutes.

TABLE 3

| Item | | Operating Condition | |
|---|---|---|---|
| pH | | 6.41 ± 0.43 | |
| DO (mg/L) | | −444.30 ± −18.94 | |
| Temp. (° C.) | | 33.23 ± 1.59 | |
| MLSS (mg/L) | 5,799 ± 2,036 | 5,799 ± 2,036 | 4,705 ± 971 |

| OLR (kg COD/m3d) | 0.75 ± 0.41 | |
|---|---|---|
| F/M ratio (d−1) | 0.16 ± 0.11 | |
| HRT (hrs) | 42 | 42 |
| SRT (days) | 60 | 60 |
| Flux (LMH) | 1.1 | 1.1 |

| | |
|---|---|
| Airation (L/min) | 2 |

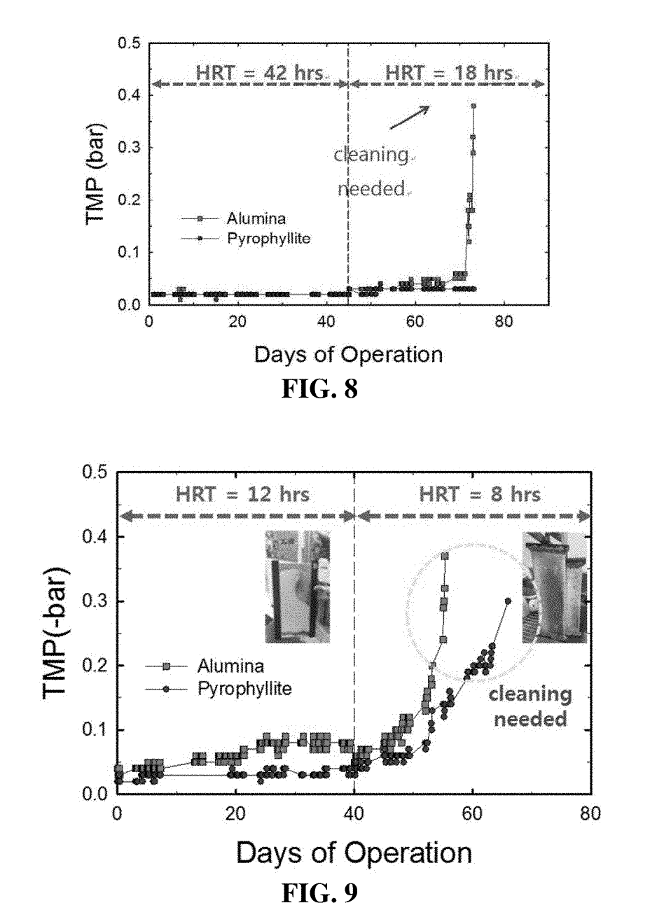

FIG. 8 is a view illustrating result of trans membrane pressure. As a result of operation (for 45 days) by setting hydraulic residence time for 42 hours, both the ceramic membrane of the present disclosure and the conventional ceramic membrane are retained less than 0.03 bar; thus they both can be found that operating is relatively stable.

Meanwhile, as a result of operation by setting hydraulic residence time for 18 hours, the conventional ceramic membrane began increasing trans membrane pressure from approximately 15 days of operating time has passed and began rapidly increasing at approximately 28 days of operating time has passed.

In contrast, the ceramic membrane according to the present disclosure has found that even though the hydraulic residence time is reduced, it is still retained stably equal to or less than 0.03 bar.

Hereinafter, an experimental example 2 using the second exemplary embodiment of the present disclosure will be described.

### Experimental Example 2

In order to confirm effect of the pyrophylite ceramic membrane according to the present disclosure the water treatment process together with conventional ceramic membrane corresponding to 0.3 mm of pore size was performed.

As indicated in table 4, representative water lever of the raw water is 293.7 mg/L of TCOD, 79.9 mg/L of TOC, 16.4 mg/L of T-N and 3.2 mg/L of T-P.

TABLE 4

| TCOD | TOC | T-N | T-P | Na | NH4—N | K | Mg | Ca |
|---|---|---|---|---|---|---|---|---|
| (mg/ | (mg/ | (mg/ | (mg/ | (mg/ | (mg/ | (mg/ | (mg/ | (mg/ |
| L) | L) | L) | L) | L) | L) | L) | L) | L) |
| 293.7 | 79.9 | 16.4 | 3.2 | 72.2 | 20.7 | 7.2 | 0.7 | 5.8 |

Table 5 indicates specific operating condition in the exemplary embodiment, pH scale of the raw water in the reactor is retained 7.13±0.25, Dissolved Oxygen (DO) is retained 7.56±0.73 (mg/L) and water temperature was controlled to retain 22.1±1.60. Also hydraulic retention time (HRT) was set as 8Hr and 12Hr, flux was set as 3 LMH and 5 LMH and it was operated to have stopping time for one minute after filtration for four minutes.

TABLE 5

| Item | | Operating Condition | |
|---|---|---|---|
| pH | | 7.13 ± 0.25 | |
| DO (mg/L) | | 7.56 ± 0.73 | |
| Temp. (° C.) | | 22.1 ± 1.60 | |
| MLSS (mg/L) | MLVSS (mg/L) | 5,715 ± 1,093 | 4,705 ± 971 |

| OLR (kg COD/m³d) | 0.69 ± 0.15 | |
|---|---|---|
| F/M ratio (d⁻¹) | 0.14 ± 0.04 | |
| HRT (hrs) | 12 | 8 |
| SRT (days) | 41 | 41 |
| Flux (LMH) | 3 | 5 |

| | |
|---|---|
| Airation (L/min) | 2 |

Table 6 is a result of average removal rate of TCOD and TOC of the permeate water. In the case of using the conventional alumina ceramic membrane, the TCOD average removal rate of the permeate water was 96% in 12 hours of HRT, 87% in 8 hours of HRT, and TOC was 98% and 87% respectively.

Meanwhile, in the ceramic membrane including the pyrophylite of the present disclosure, the TCOD average removal rate of the permeate water was 96% in 12 hours of the HRT and the TOC was 98%, thus a result that is similar to the conventional membrane was obtained. Also even though the HRT was set for 8 hours, it was found that the TCOD average removal rate was 92% and the TOC was 90%; thus, the TCOD and the TOC were more removed than the conventional ceramic membrane.

TABLE 6

| | | | | Pyrophyllite | |
|---|---|---|---|---|---|
| | | Conventional Alumina | | Minerals Ceramic | |
| | | Ceramic Membrane | | Membrane | |
| Item | Outflow Water | HRT 12 Hr | | HRT 8 Hr | |
| TCOD | 293.7 ± 15.9 | 96% | 87% | 96% | 92% |
| TOC | 79.9 ± 12.1 | 98% | 87% | 97% | 90% |

FIG. 9 is a view illustrating result of trans membrane pressure. As a result of operation during 40 days by setting the hydraulic residence time for 12 hours, the conventional ceramic membrane is operated relatively stable since the trans membrane pressure retains 0.04 bar ˜0.1 bar; however, the pyrophylite ceramic membrane of the present disclosure is maximum 0.05 bar so operating with lower differential pressure than the conventional ceramic membrane is capable.

Meanwhile, as a result of operation by setting hydraulic residence time for 8 hours, the conventional ceramic membrane was increased up to differential pressure required chemicals cleaning, while the pyrophylite ceramic membrane of the present disclosure was possible to filter for about 26 days which is extended about 8 days compared to the conventional ceramic membrane.

As described above, the pyrophylite ceramic membrane of the present disclosure has excellent removal capability with reference to organic materials compared to the conventional ceramic membrane, in particular, periods required to the chemicals cleaning may be extended while retaining the trans membrane pressure lower, thereby having an effect of reducing required power cost for membrane operation and for chemicals cleaning.

While this invention has been described in detail, it is to be understood that the invention is just preferred mode to those skilled in the art, and is not construed as being limited to the modes set forth herein, but, on the contrary, it is clear to those skilled in the art that it is intended to cover various modifications and equivalent arrangements included within the spirit and scope of the present invention, and these modifications and equivalent arrangements are included within the appended claims.

What is claimed is:

1. A method for water treatment process using pyrophylite ceramic membrane including pyrophylite with 80 weight and alumina with 20 weight, comprising:
a S-1 step which pyrophylite ceramic membrane 10 is embedded and raw water is supplied to a reactor 100 that is blocked from outside;
a S-2 step which obtains permenate water by operating suction pump 130 connected with the pyrophylite ceramic membrane 10;
a S-3 step which recovers gas generated from the reactor 100; and
a S-4 step which circulates part of gas generated from the reactor 100 to the reactor 100.

2. The method for water treatment process using the pyrophylite ceramic membrane according to claim 1, wherein the S-1 step is characterized in that if water level of the reactor 100 reaches less than a set point the raw water is supplied and reaches greater than the set point supplying of the raw water is discontinued.

3. The method for water treatment process using the pyrophylite ceramic membrane according to claim 1, gas generated from the reactor 100 comprises methane gas, CO2 and nitrogen gas.

4. The method for water treatment process using the pyrophylite ceramic membrane according to claim 2, gas generated from the reactor 100 comprises methane gas, CO2 and nitrogen gas.

5. The method for water treatment process using the pyrophylite ceramic membrane according to claim 1, wherein the S-4 step circulating part of gas generated from the reactor 100 to the reactor 100 is characterized by supplying the gas to a diffuser 110 which is located at a lower portion of the pyrophylite ceramic membrane 10.

6. The method for water treatment process using the pyrophylite ceramic membrane according to claim 2, wherein the S-4 step circulating part of gas generated from the reactor 100 to the reactor 100 is characterized by supplying the gas to a diffuser 110 which is located at a lower portion of the pyrophylite ceramic membrane 10.

7. A method for the water treatment using the pyrophylite ceramic membrane including pyrophylite with 80 weight and alumina with 20 weight, comprising:
a S′-1 step which supplies raw water to reactor embedded in pyrophylite ceramic membrane 10;
a S′-2 step which obtains permeate water by operating suction pump 130 connected with the pyrophylite ceramic membrane 10; and
a S′-3 step which supplies air to the reactor 100.

8. The method for water treatment process using the pyrophylite ceramic membrane according to claim 7, wherein the S′-1 step is characterized that if water level of the reactor 100 reaches less than a set point the raw water is supplied and reaches greater than the set point supplying of the raw water is discontinued.

9. The method for water treatment process using the pyrophylite ceramic membrane according to claim 7, wherein gas supplying to the reactor 100 is pressed air.

10. The method for water treatment process using the pyrophylite ceramic membrane according to claim 8, wherein gas supplying to the reactor 100 is pressed air.

11. The method for water treatment process using the pyrophylite ceramic membrane according to claim 7, wherein the S′-3 step is characterized by supplying air to a diffuser 110 which is located at a lower portion of the pyrophylite ceramic membrane 10.

12. The method for water treatment process using the pyrophylite ceramic membrane according to claim 8, wherein the S′-3 step is characterized by supplying air to a diffuser 110 which is located at a lower portion of the pyrophylite ceramic membrane 10.
